(19) United States
(12) Patent Application Publication
(10) Pub. No.: US 2009/0134762 A1
(43) Pub. Date: May 28, 2009

(54) ELECTRIC DISCHARGE LAMP

(75) Inventors: Takuya SERITA, Shizuoka (JP); Toru ITO, Shizuoka (JP)

Correspondence Address: SUGHRUE-265550, 2100 PENNSYLVANIA AVE. NW, WASHINGTON, DC, 20037-3213, US

(73) Assignee: KOITO MANUFACTURING CO., LTD., Tokyo (JP)

(21) Appl. No.: 12/260,152

(22) Filed: Oct. 29, 2008

(30) Foreign Application Priority Data
Nov. 22, 2007 (JP) 2007-302880

(51) Int. Cl. H01J 61/40; H01J 5/00

(52) U.S. Cl. 313/113; 313/317; 313/110

(57) ABSTRACT

An electric discharge lamp is provided. The electric discharge lamp includes a ceramic luminous tube; electrodes held by the ceramic luminous tube; a first outer tube which is made of glass and covers the ceramic luminous tube to form a first space between the ceramic luminous tube and the first outer tube; and a second outer tube which is made of glass and covers the first outer tube to form a second space between the first outer tube and the second outer tube. A vacuum is formed in the first space.

### BACKGROUND OF THE INVENTION

1. Field of the Invention

Devices consistent with the present invention relate to discharge lamps and, more particularly, to preventing the generation of cracks in discharge lamps.

2. Description of Related Art

In a headlight for a vehicle, for example, an incandescent lamp or a halogen lamp may be used as a luminous source. Alternatively, an electric discharge lamp (electric discharge bulb) may be used as the luminous source.

When an incandescent lamp or a halogen lamp is used as the luminous source, a filament of the incandescent lamp or the halogen lamp is substantially uniformly luminous and formed into a rod-shaped luminous portion. Therefore, when the incandescent lamp or the halogen lamp is used for a reflection type lighting device in which a reflector is used, it is easy to control the light distribution using a shape of the reflecting face of the reflector.

On the other hand, when an electric discharge lamp is used as a luminous source, a quantity of light of the electric discharge lamp is larger than that of the incandescent lamp or the halogen lamp. Thus, it is possible to enhance the luminance. Further, the life of the electric discharge lamp is longer than that of the incandescent lamp or the halogen lamp.

As described above, the luminance of the electric discharge lamp is longer than that of the incandescent lamp or the halogen lamp and the life of the electric discharge lamp is longer than that of the incandescent lamp or the halogen lamp. Accordingly, in part for these reasons, a vehicle headlight using the electric discharge lamp has come into wide use.

However, the electric discharge lamp has some disadvantages. For example, a luminous tube made of glass is used in which a pair of electrodes are held, and a rare gas is filled in the luminous tube. However, the luminous tube made of glass is corroded by metallic halide filled in the luminous tube such that blackening and devitrification occur. This blackening and devitrification makes it difficult to obtain a proper light distribution. Further, since the corrosion is an ongoing process, the life of the discharge lamp is shortened.

Therefore, an electric discharge lamp having a ceramic luminous tube has been proposed. An example of a related art electric discharge lamp having a ceramic luminous tube is described in Japanese Unexamined Patent Publication No. JP-A-2004-103461.

In the related art electric discharge lamp described in JP-A-2004-103461, a pair of electrodes are held in the ceramic luminous tube and respectively connected to lead wires. The pair of lead wires are respectively joined to end portions of the ceramic luminous tube. Therefore, a hermetically closed space is formed in the ceramic luminous tube. The hermetically closed space formed in the ceramic luminous tube is filled with rare gas and metallic halide. The ceramic luminous tube is covered with an outer tube made of glass such that a hermetically closed space is formed between the ceramic luminous tube and the outer tube.

Since the ceramic luminous tube is stable with respect to metallic halide, the life of the related art electric discharge tube configured as described above is longer than that of the electric discharge tube for a vehicle having a glass luminous tube.

However, the related art electric discharge lamp having the ceramic discharge tube as described above also has some disadvantages. For example, the strength of the ceramics used as the material for forming the luminous tube is low when a temperature of the ceramics is suddenly changed. Therefore, the related art electric discharge lamp described in JP-A-2004-103461 has a disadvantage in that cracks are generated in the ceramic luminous tube when turning off the light.

Along with the cracks that are generated as described above, there is a possibility that the ceramic luminous tube will burst.

### SUMMARY OF THE INVENTION

Exemplary embodiments of the present invention address the above disadvantages and other disadvantages not described above. However, the present invention is not required to overcome the disadvantages described above, and thus, an exemplary embodiment of the present invention may not overcome any of the disadvantages described above.

Accordingly, it is an aspect of the invention to provide an electric discharge lamp which prevents the generation of cracks in a ceramic luminous tube.

According to an exemplary embodiment of the present invention, there is provided an electric discharge lamp including a ceramic luminous tube; a plurality of electrodes held by the ceramic luminous tube; a first outer tube which is made of glass and covers the ceramic luminous tube to form a first space between the ceramic luminous tube and the first outer tube; and a second outer tube which is made of glass and covers the first outer tube to form a second space between the first outer tube and the second outer tube, wherein the first space is a vacuum.

According to another exemplary embodiment of the present invention, there is provided a electric discharge lamp including a ceramic luminous tube; two electrodes which are connected to respective ends of the ceramic luminous tube; a first outer tube which encloses the ceramic luminous tube, the ends of the first outer tube closing around respective ones of the electrodes to form a first space between the ceramic luminous tube and the first outer tube; and a second outer tube which encloses the first outer tube, the ends of the second outer tube closing around respective ones of the electrodes to form a second space between the first outer tube and the second outer tube, wherein the first space is a vacuum.

### BRIEF DESCRIPTION OF THE DRAWINGS

FIG. 1 is a view showing an outline of a headlight according to an exemplary embodiment of the present invention;

FIG. 2 is an enlarged side sectional view in which a portion of an electric discharge lamp, according to an exemplary embodiment of the present invention, of the headlight of FIG. 1 is shown;

FIG. 3 is an enlarged sectional view showing a ceramic luminous tube and an electrode of the electric discharge lamp of FIG. 2; and

FIG. 4 is an enlarged side sectional view showing a shading film formed on a first outer tube of an electric discharge lamp according to an exemplary embodiment of the present invention.

### DETAILED DESCRIPTION OF EXEMPLARY EMBODIMENTS OF THE PRESENT INVENTION

Referring to the accompanying drawings, exemplary embodiments of the present invention will be explained below. According to exemplary embodiments of the present invention, an electric discharge lamp is provided for use in a headlight for a vehicle.

Headlights for a vehicle are respectively attached to both end portions on the right and left at a front end portion of the vehicle.

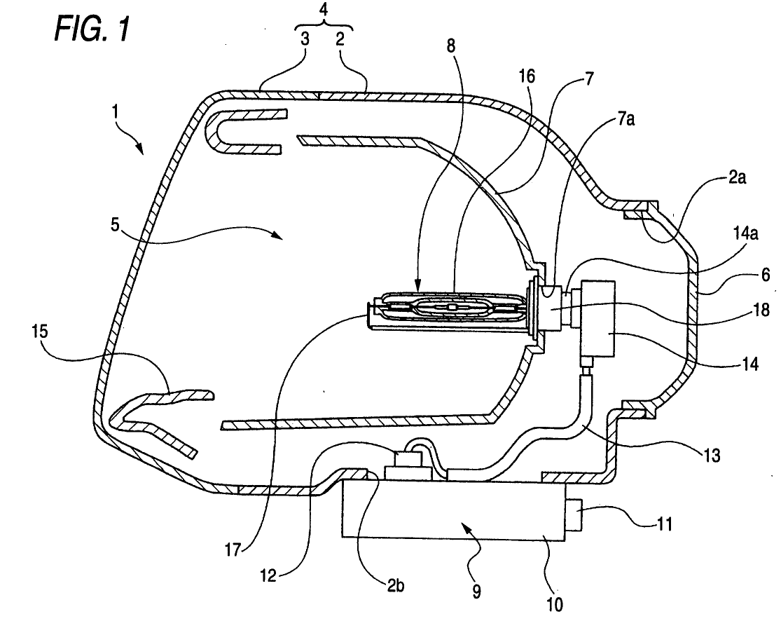

As shown in FIG. 1, each headlight 1 includes a lamp housing 2 having a recess portion open to the front and a cover 3 for closing an opening face of the lamp housing 2. The lamp housing 2 and the cover 3 make a lighting device outer housing 4. An inner space of the lighting device outer housing 4 is formed into a lighting chamber 5. The lamp housing 2 and the cover 3 are made of, for example, a resin material.

An insertion hole 2a penetrating in the longitudinal direction is formed at a rear end portion of the lamp housing 2. The insertion hole 2a is closed by a back cover 6. At a lower end portion of the lamp housing 2, an arrangement hole 2b penetrating in the vertical direction is formed.

In the lighting chamber 5, a reflector 7 is supported by an optical axis adjusting mechanism (not shown) so as to be capable of tilting. The reflector 7 is made of, for example, a resin material. At a rear end portion of the reflector 7, an attaching hole 7a penetrating in the longitudinal direction is formed.

An electric discharge lamp 8 is attached to the attaching hole 7a of the reflector 7.

An electric discharge lamp lighting device 9 is attached to the arranging hole 2b of the lamp housing 2. A lighting circuit (not shown) is accommodated in a case body 10 of the electric discharge lamp lighting device 9. On an outer circumferential face of the case body 10, an input side connector 11 is provided. On an upper face of the case body 10, the output side connector 12 is provided. The input side connector 11 is connected to an electric power supply circuit (not shown).

The output side connector 12 is connected to a starting device 14 through a feeder cord 13. A connector 14a of the starting device 14 is connected to a socket, which will be described in more detail later, of the electric discharge lamp 8.

The electric discharge lamp 8 is turned on as follows. A voltage of the electric power supply circuit is boosted up by the lighting circuit of the electric discharge lamp lighting device 9. At the same time, the voltage is converted from direct current (DC) to alternative current (AC) so as to obtain a lighting voltage which is a high AC voltage. The thus obtained lighting voltage is provided to the electric discharge lamp 8 through the feeder cord 13 and the starting device 14. In this way, the electric discharge lamp 8 is turned on.

An extension 15 shielding a portion of each component arranged in the lighting chamber 5 is arranged in the lighting chamber 5. A shade (not shown) for shading a portion of light emergent from the electric discharge lamp 8 is arranged in the lighting chamber 5.

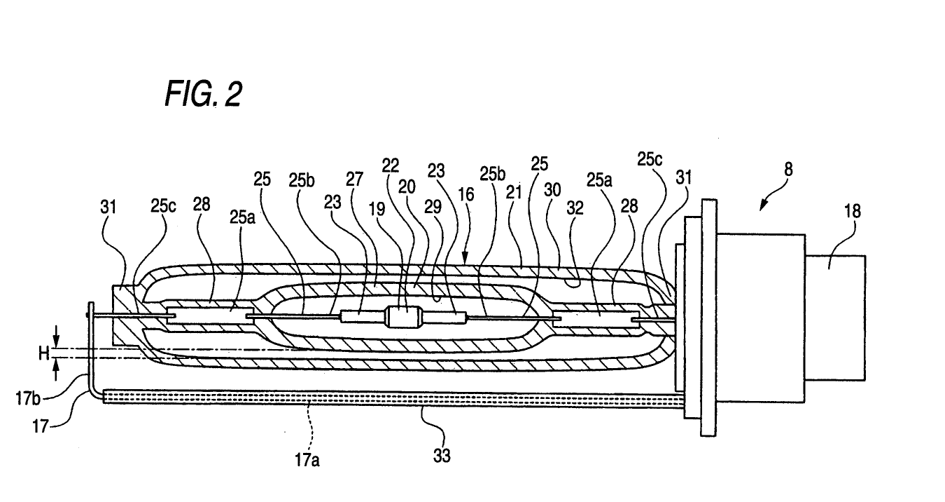

The electric discharge lamp 8 is formed by connecting a body 16 and an external lead wire 17 to a socket 18 (see FIG. 2).

Turning to FIG. 2, the body 16 includes a ceramic luminous tube 19, a first outer tube 20 for covering the ceramic luminous tube 19 and a second outer tube 21 for covering the first outer tube 20.

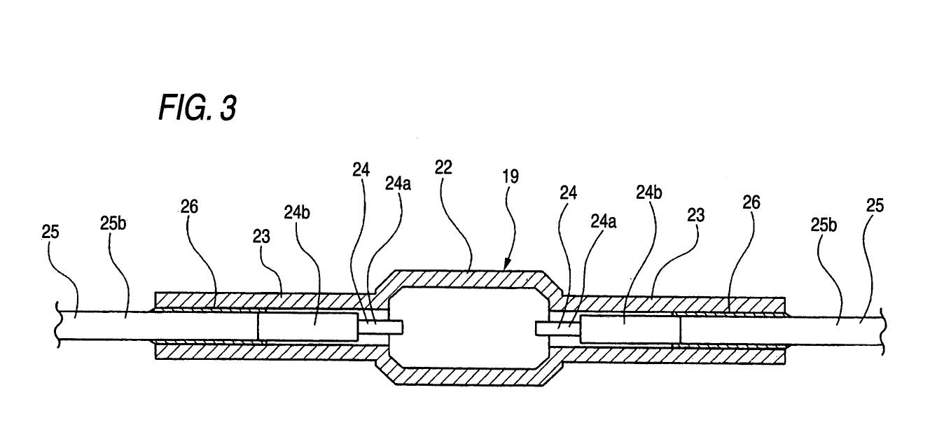

The ceramic luminous tube 19 is made of ceramics. As shown in FIG. 3, in the ceramic luminous tube 19, a luminous portion 22, and small tube portions 23, 23, which are respectively connected to end portions of the luminous portion 22, are integrated into one body. An outer diameter of the small diameter portions 23, 23 is smaller than an outer diameter of the luminous portion 22.

In the luminous portion 22, a metallic halide and a rare gas such as, for example, xenon or argon are filled.

In general, the ceramic luminous tube is stable with respect to metallic halide. Therefore, the ceramic luminous tube is advantageous in that the life is longer than that of the glass luminous tube. The heat resistance property of the ceramic luminous tube is higher than that of the glass luminous tube and the degree of freedom of forming of the ceramic luminous tube is advantageously high.

As shown in FIG. 3, in the small tube portions 23, 23, portions of electrodes 24, 24 are respectively arranged. The electrode 24 is formed to be long in the longitudinal direction. An electric discharge electrode portion 24a and a connecting electrode portion 24b are continuously arranged in this order from the luminous portion 22 side. In other words, the electric discharge electrode portion 24a extends from its respective small tube portion 23 into the luminous portion 22, and the connecting electrode portion 24b extends out of its respective small tube portion 23. The electric discharge electrode portion 24a is made of, for example, tungsten. The connecting electrode portion 24b is made of, for example, molybdenum.

End portions of the electric discharge electrode portions 24a which are opposed to each other are respectively positioned inside the luminous portion 22.

As shown in FIGS. 2 and 3, lead wires 25, 25 are connected to end portions of the respective electrodes 24, 24 and extend in the longitudinal direction. Each lead wire 25 includes a piece of molybdenum foil 25a positioned at an intermediate portion and connecting portions 25b, 25c connected to respective end portions of the piece of molybdenum foil 25a. The connecting portions 25b, 25c are made of, for example, niobium or thermet (i.e., a compound material in which ceramic particles are dispersed in a metallic matrix) and the coefficient of linear expansion of the connecting portions 25b, 25c is substantially the same as that of the ceramic luminous tube 19.

Portions of the connecting portions 25b, 25b connected to the end portions on the ceramic luminous tube 19 are respectively inserted into the small diameter portions 23, 23 of the ceramic luminous tube 19 and connected to the connecting electrodes 24b, 24b of the electrodes 24, 24. Portions of the connecting portions 25b, 25b inserted into the small diameter portions 23, 23 are respectively joined to the small diameter portions 23, 23 by frit glass 26, 26 (see FIG. 3). When the connecting portions 25b, 25b are respectively joined to the small diameter portions 23, 23 by the frit glass 26, 26, a hermetically closed space is formed in the ceramic luminous tube 19.

As shown in FIG. 2, the ceramic luminous tube 19 is covered with the first outer tube 20. The first outer tube 20 is formed in such a manner that a blockade portion 27 for covering the ceramic luminous tube 19 is integrated with holding portions 28, 28, which are respectively provided at the front and rear end portions of the blockade portion 27, such that the blockade portion 27 and the holding portions 28 form one continuous body of, for example, quartz glass. In the holding portions 28, 28, the pieces of molybdenum foil 25a, 25a of the lead wires 25, 25 are respectively held and embedded.

The ceramic luminous tube 19 is covered with the blockade portion 27 of the first outer tube 20. Thus, a first space 29, which is a hermetically closed space, is formed between the ceramic luminous tube 19 and the blockade portion 27. The first space 29 is placed into a vacuum state. Herein, the vacuum state denotes a state in which gas such as air is completely removed and also includes a state in which a pressure is not more than about 100 Pa.

Since the first space 29 is in the vacuum state as described above, little to no convection is generated in the first space 29. Accordingly, when the first space is put into the vacuum state, the heat insulation property is enhanced and, when the electric discharge lamp 8 is turned off, the cooling rate of the ceramic luminous tube 19 is moderated, and the ceramic luminous tube 19 is prevented from being rapidly cooled.

The first outer tube 20 is covered with the second outer tube 21. The second outer tube 21 is formed in such a manner that a blockade portion 30 for covering the first outer tube 20 is integrated with joining portions 31, 31, which are respectively provided at end portions in the longitudinal direction of the blockade portion 30 such that the blockade portion 30 and the joining portions 31, 31 form one continuous body of, for example, quartz glass. The joining portions 31, 31 are respectively fused and joined to end portions of the holding portions 28, 28 of the first outer tube 20.

The first outer tube 20 is covered with the blockade portion 30 of the second outer tube 21. Thus, a second space 32, which is a hermetically closed space, is formed between the first outer tube 20 and the blockade portion 30. In the second space 32, a rare gas such as xenon or argon, or nitrogen is filled at a pressure lower than the pressure in the first space 29. For example, the pressure in the second space 32 may be about 5 kPa to about 40 kPa. Since the rare gas described above is filled in the second space 32, when an electric discharge from the electrodes 24, 24 occurs in the ceramic luminous tube 19, voltage is impressed upon the pieces of molybdenum foil 25a, 25a of the lead wires 25, 25. Accordingly, ultraviolet rays are generated in the second space 32. The ultraviolet rays which are generated act on the inside of the ceramic luminous tube 19 through the first outer tube 20 and the first space 29. Accordingly, an electric discharge executed in the ceramic luminous tube 19 is facilitated by the ultraviolet rays. Accordingly, when the second space 32 is filled with a gas such as a rare gas, it is possible to reduce a starting voltage of the electric discharge lamp 8 at the time of lighting.

Accordingly, when the pressure of the gas filled into the second space 32 is set at a low pressure of, for example, about 5 kPa to about 40 kPa, the quantity of ultraviolet rays which is emitted is increased, and the electric discharge can be further facilitated and furthermore a heat insulation property can be enhanced. Therefore, the cooling rate of the ceramic luminous tube 19 when the electric discharge lamp 8 is turned off can be more easily moderated. However, when the pressure of the gas filled into the second space 32 is lower than about 5 kPa, no ultraviolet rays are generated in the second space 32 at the time of electrically discharging from the electrodes 24, 24 in the ceramic luminous tube 19, and it is difficult to facilitate the electric discharge executed in the ceramic luminous tube 19.

As described above, the second outer tube 21 is made of quartz glass through which the ultraviolet rays may be transmitted. However, the second outer tube 21 may be alternatively made by adding an additive for shielding the ultraviolet rays. When the second outer tube 21 includes the additive for shielding ultraviolet rays, the ultraviolet rays contained in the light generated at the time of electric discharge in the ceramic luminous tube 19 can be prevented, and ultraviolet rays generated in the second space 32 can be prevented from radiating from the second outer tube 21 to the outside. Accordingly, for example, the cover 3 and reflector 7, which are made of resin material, can be prevented from being deteriorated by ultraviolet rays. Further, it is possible to prevent the ultraviolet rays from radiating from the headlight, and affecting, for example, a human body.

However, when the second outer tube 21 is made by adding an additive to the quartz glass, there is a possibility that a heat insulation property of the second outer tube 21 will be lowered. Therefore, it is advantageous if a determination to add an additive and a determination of how much additive to add are made by considering both the heat insulation properties and the prevention of the generation of ultraviolet rays.

In the example described above, the additive is added to the second outer tube 21 to provide shielding of ultraviolet rays. However, for example, it is possible to add the additive to the first outer tube 20 instead of the second outer tube 21. However, if the additive is added to the first outer tube 20 to provide shielding of ultraviolet rays, when an electric discharge from the electrodes 24, 24 occurs in the ceramic luminous tube 19, it is difficult to facilitate an electric discharge using the ultraviolet rays generated in the second space 32. Therefore, it is advantageous to add the additive to the second outer tube 21 rather than the first outer tube 20.

Returning to FIG. 2, assuming that a front end of the electric discharge lamp 8 is the end that is located away from the socket 18, an end portion of the lead wire 25 at the front end of the electric discharge lamp 8 is protruded from the joining portion 31 on the front end of the second outer tube 21. That is, specifically, the connecting portion 25c of the lead wire 25 extends through the joining portion 31 on the front end of the electric discharge lamp 8 and outside of the second outer tube 21.

At the rear end of the electric discharge lamp, the connecting portion 25c of the lead wire 25 on the rear end of the electric discharge lamp 8 extends backward from the joining portion 31 at the rear end of the electric discharge lamp 8, and is connected to a first connecting terminal (not shown) provided in the socket 18. At the front end of the electric discharge lamp 8, the connecting portion 25c of the lead wire 25 on the front end of the electric discharge lamp 8 extends forward from the joining portion 31 at the front end of the electric discharge lamp 8, and is connected to an external lead wire 17. The external lead wire 17 includes a horizontal portion 17a extending in the longitudinal direction on the lower side outside of the second outer tube 21 and a vertical portion 17b bent at a front end portion of the horizontal portion 17a and extending in the vertical direction. A rear end portion of the horizontal portion 17a is connected to a second connecting terminal (not shown) provided in the socket 18. An upper end portion of the vertical portion 17b is joined to the end portion of the connecting portion 25c of the lead wire 25 extending through the joining portion 31 at the front end of the electric discharge lamp 8, for example, by welding. An insulating sleeve 33 is attached to the horizontal portion 17a of the external lead wire 17.

As described above, in the electric discharge lamp 8 according to an exemplary embodiment of the present invention, since the external lead wire 17 is arranged outside the second outer tube 21, it is possible to reduce a clearance H (see FIG. 2) between an outer circumferential face in the blockade portion 27 of the first outer tube 20 and an inner circumferential face of the blockade portion 30 of the second outer tube 21. Corresponding to the reduction of the clearance H, it is possible to position the second outer tube 21 close to the first outer tube 20. Accordingly, a heat insulation property of the electric discharge lamp 8 can be enhanced.

When the external lead wire 17 is arranged outside the second outer tube 21, it is possible to reduce the dimensions of the second outer tube 21. Therefore, it is difficult for the light, which emerges from the luminous portion 22 and is reflected by the reflector 7, to be shaded by the second outer tube 21. Accordingly, the light distribution can be more easily controlled.

In the electric discharge lamp 8 according to an exemplary embodiment of the present invention, the external lead wire 17 is arranged outside the second outer tube 21. Accordingly, the holding portions 28, 28 of the first outer tube 20 and the joining portions 31, 31 of the second outer tube 21 are respectively joined to each other and the inner space is closed. Accordingly, in the electric discharge lamp 8, the first outer tube 20 and the second outer tube 21 are joined to each other in two portions, that is, the front and the rear portions. Therefore, strength of the electric discharge lamp 8 is increased and an anti-vibration property of the electric discharge lamp 8 can be enhanced. Further, a positional shift between the first outer tube 20 and the second outer tube 21 is minimized. Therefore, the positional accuracy of the first outer tube 20 and the second outer tube 21 can be enhanced.

In the electric discharge lamp 8 according to an exemplary embodiment of the present invention, it is possible to form a conductive film on the outer face of the first outer tube 20. If the conductive film is formed, a discharging phenomenon is caused in the second space 32 during electric discharge in the ceramic luminous tube 19 by an action of the conductive film. Thus, electric discharge can be facilitated in the ceramic luminous tube 19. Accordingly, when the conductive film is formed on the outer face of the first outer tube 20, the starting voltage at the time of turning on the electric discharge lamp 8 can be decreased.

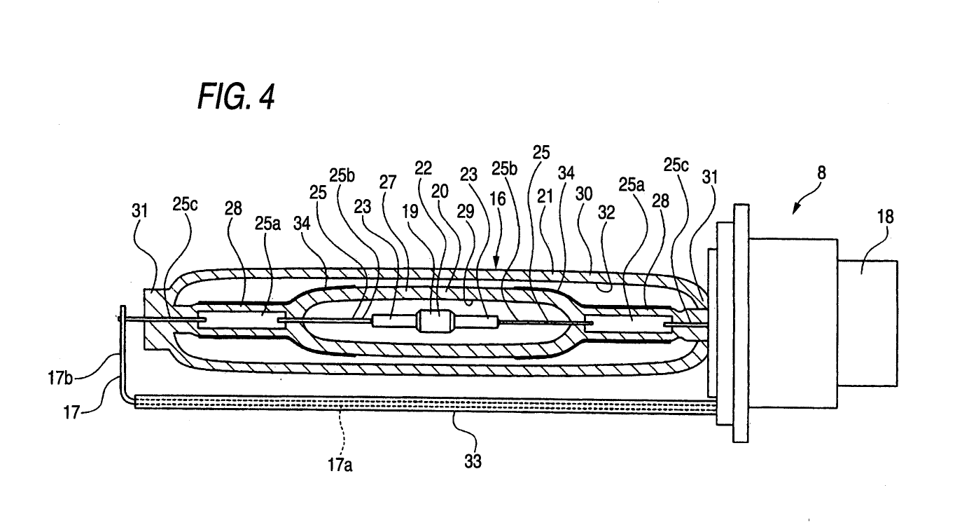

As shown in FIG. 4, in the electric discharge lamp 8, shading films 34, 34 may be formed in portions in the longitudinal direction of the first outer tube 20 except for the central portion. When the shading films 34, 34 are formed on the first outer tube 20 as described above, it is possible to prevent the light from emerging from the portions where the shading films 34, 34 are formed. When light is prevented from emerging from the electric discharge lamp, it is possible to prevent the generation of a dazzling light projected towards an opponent vehicle.

Alternatively, it is possible to prevent light from emerging by providing the shading films 34, 34 on an outer face of the ceramic luminous tube 19. However, when the shading films 34, 34 are formed on the ceramic luminous tube 19, there is a possibility that the shading films 34, 34 will become peeled off due to the heat generated by the ceramic luminous tube 19 and a heat resisting property of the shading films 34, 34. Therefore, it is advantageous if the shading films 34, 34 are formed on the first outer tube 20.

It is also possible to prevent light from emerging if the shading films 34, 34 are formed on an outer face of the second outer tube 21. However, if the shading films 34, 34 are formed on the second outer tube 21, the range over which the shading films 34, 34 are provided is disadvantageously increased. Therefore, it is advantageous if the shading films 34, 34 are formed on the first outer tube 20.

In the electric discharge lamp 8 according to an exemplary embodiment of the present invention, a reflecting film may be formed on a substantially lower half portion of the outer face of the first outer tube 20. If the reflecting film is formed on the substantially lower half portion of the outer face of the first outer tube 20, light which emerges downward from the luminous portion 22 is reflected by the reflecting film so that the light emerges only upward from the electric discharge lamp 8. Therefore, it becomes easier to control a light distribution and the efficiency of using light can be enhanced.

In the related art electric discharge lamp, when the ceramic luminous tube is rapidly cooled at a time of turning off the light, an intense heat shock is given to the ceramic luminous tube. During the time that the lamp is lit, the ceramic luminous tube expands. Thus, at the time when the light is turned off, an outer face of the ceramic luminous tube of the related art electric discharge lamp is cooled first and contracted. Due to this contraction, cracks are likely to be generated inside the ceramic luminous tube of the related art electric discharge lamp.

By contrast according to exemplary embodiments of the present invention, as described above, the electric discharge lamp 8 includes the first outer tube 20 made of a quartz glass and covering the ceramic luminous tube 19 and the second outer tube 21 made of a quartz glass and covering the first outer tube 20, wherein the first space 29 formed between the ceramic luminous tube 19 and the first outer tube 20 is a vacuum.

Thus, according to exemplary embodiments of the present invention, the heat insulating property is enhanced and the cooling rate of the ceramic luminous tube 19 at the time of turning off the electric discharge lamp 8 is suppressed so that the ceramic luminous tube 19 is prevented from being rapidly cooled. Accordingly, the ceramic luminous tube 19 can be prevented from being cracked at the time of turning off the electric discharge lamp 8.

According to a second aspect of the invention, the second space may be filled with a gas for generating ultraviolet rays at the time of applying voltage to the pair of electrodes.

According to a third aspect of the invention, the second outer tube may be made of material capable of shielding the ultraviolet rays and the first outer tube may be made of material capable of transmitting the ultraviolet rays.

According to a fourth aspect of the invention both end portions of the first outer tube in a direction of an arrangement of the pair of electrodes are joined to each other so as to hermetically close the first space, and both end portions of the second outer tube in the direction of the arrangement of the pair of electrodes are joined to each other so as to hermetically close the second space and external lead wires, which are connected to the pair of electrodes so as to apply voltage to the pair of electrodes, are arranged outside the second outer tube.

Accordingly, in the electric discharge lamp according to exemplary embodiment of the present invention, a cooling rate of the ceramic luminous tube at the time of turning off the light can be moderated.

In the above electric discharge lamp for a vehicle, when both end portions of the first and the second outer tube in an arranging direction of the pair of electrodes are respectively joined to each other, the first and the second space are respectively formed into hermetically closed spaces and the external lead wires, which are connected to the pair of electrodes for applying voltage to the pair of electrodes, can be arranged outside the second outer tube. According to this configuration, a clearance formed between the first and the second outer tube can be reduced and the heat insulation property can be enhanced. Accordingly, it becomes possible to further moderate a cooling rate of the ceramic luminous tube at the time of turning off the light.

The electric discharge lamp according to exemplary embodiments of the present invention includes a ceramic luminous tube made of ceramics; a pair of electrodes held by the ceramic luminous tube; a first outer tube which is made of glass and covers the ceramic luminous tube and a second outer tube which is made of glass and covers the first outer tube, wherein a first space is formed between the ceramic luminous tube and the first outer tube, a second space is formed between the first outer tube and the second outer tuber and the first space is a vacuum.

Accordingly, the heat insulation property is enhanced and the cooling rate of the ceramic luminous tube at the time of turning off the electric discharge tube is moderated. Therefore, it becomes possible to prevent the ceramic luminous tube from being rapidly cooled. Accordingly, it is possible to prevent the ceramic luminous tube from being cracked.

According to the second aspect of the invention, the second space is filled with a gas for generating ultraviolet rays at the time of applying voltage to the pair of electrodes. Accordingly, the ultraviolet rays are generated, and an electric discharge executed in the ceramic luminous tube is facilitated and it becomes possible to reduce a starting voltage at the time of turning on the electric discharge lamp.

According to a third aspect of the invention, the second outer tube is made of a material capable of shielding the ultraviolet rays, and the first outer tube is made of material capably of transmitting the ultraviolet rays. Accordingly, it is possible to prevent ultraviolet rays from emerging from the second outer tube to the outside. Thus, it is possible to prevent a human body from being irradiated with ultraviolet rays and it is also possible to prevent parts, which form the lighting device, such as a reflector and a front cover made of resin material from being irradiated with ultraviolet rays.

According to a fourth aspect of the invention, both end portions of the first outer tube in a direction of an arrangement of the pair of electrodes are joined to each other so as to hermetically close the first space, both end portions of the second outer tube in the direction of the arrangement of the pair of electrodes are joined to each other so as to hermetically close the second space, and external lead wires, which are connected to the pair of electrodes so as to apply voltage to the pair of electrodes, are arranged outside the second outer tube. Therefore, it is possible to reduce a clearance between the first and the second outer tube. Accordingly, the second outer tube can be arranged close to the first outer tube, and the heat insulation property can be enhanced.

The shape and structure of each portion shown in the exemplary embodiments of the present invention described above are just examples for realizing the present invention. It should be noted that the technical range of the present invention is not limited to the above specific examples.

While the invention has been described in connection with certain exemplary embodiments, various changes and modifications may be made therein without departing from the scope of the present invention, and it is aimed, therefore, to cover in the appended claim all such changes and modifications as fall within the true spirit and scope of the present invention.

What is claimed is:

1. An electric discharge lamp comprising:
a ceramic luminous tube;
a plurality of electrodes held by the ceramic luminous tube;
a first outer tube which is made of glass and covers the ceramic luminous tube to form a first space between the ceramic luminous tube and the first outer tube; and
a second outer tube which is made of glass and covers the first outer tube to form a second space between the first outer tube and the second outer tube,
wherein the first space is a vacuum.

2. The electric discharge lamp according to claim 1, wherein
the second space is filled with a gas.

3. The electric discharge lamp according to claim 2, wherein the gas is a gas which generates ultraviolet rays when a voltage is applied to the electrodes.

4. The electric discharge lamp according to claim 3, wherein
the glass of the second outer tube is a quartz glass comprising an additive such that the glass of the second outer tube shields the ultraviolet rays, and
the glass of the first outer tube is a quartz glass.

5. The electric discharge lamp according to claim 1, wherein
each of the end portions of the first outer tube in a longitudinal direction is closed around a respective one of the electrodes to hermetically close the first space,
each of the end portions of the second outer tube in a longitudinal direction is closed around a respective one of the electrodes to hermetically close the second space, and
a plurality of lead wires are connected to respective ones of the plurality of electrodes and are arranged outside the second outer tube.

6. An electric discharge lamp comprising:
a ceramic luminous tube;
two electrodes which are connected to respective ends of the ceramic luminous tube;
a first outer tube which encloses the ceramic luminous tube, the ends of the first outer tube closing around respective ones of the electrodes to form a first space between the ceramic luminous tube and the first outer tube; and
a second outer tube which encloses the first outer tube, the ends of the second outer tube closing around respective ones of the electrodes to form a second space between the first outer tube and the second outer tube,
wherein the first space is a vacuum.

7. The electric discharge lamp according to claim 6, wherein the second space is filled with a gas.

8. The electric discharge lamp according to claim 6,
wherein the ends of the first outer tube which close around the respective ones of the electrodes hermetically seal the first space, and
the ends of the second outer tube which close around the respective ones of the electrodes hermetically seal the second space.

9. The electric discharge lamp according to claim 8,
wherein a pressure in the first space is less than or equal to approximately 100 Pa, and
a pressure in the second space is from approximately 5 kPa to approximately 40 kPa.

10. The electric discharge lamp according to claim 6, further comprising at least one lead wire which is connected to one of the two electrodes and which is provided outside of the second outer tube.

11. The electric discharge lamp according to claim 6, wherein the first outer tube and the second outer tube are made of glass.

12. The electric discharge lamp according to claim 11, wherein the glass of the second outer tube comprises an additive to prevent ultraviolet rays from passing through the glass.

13. The electric discharge lamp according to claim 6, wherein a conductive film is formed on at least a portion of an outer face of the first outer tube.

14. The electric discharge lamp according to claim 6, wherein a shading film is formed on portions in a longitudinal direction of the first outer tube.

15. The electric discharge lamp according to claim 6, wherein a reflective film is formed on a portion of an outer face of the first outer tube.
